(19) United States
(12) Patent Application Publication
(10) Pub. No.: US 2024/0383753 A1
(43) Pub. Date: Nov. 21, 2024

(54) CARBON FOAM MATERIALS

(71) Applicant: UNIVERSITY OF LIMERICK, Limerick (IE)

(72) Inventors: Maurice COLLINS, Limerick (IE); Mario Culebras RUBIO, Limerick (IE)

(21) Appl. No.: 18/696,525

(22) PCT Filed: Sep. 29, 2022
(86) PCT No.: PCT/EP2022/077147

§ 371 Date: Mar. 28, 2024

(30) Foreign Application Priority Data
Sep. 30, 2021 (GB) 2114017.3

(51) Int. Cl. C01B 32/05; C08J 3/075; C08J 3/24; C08J 9/28; C08J 9/36

(52) U.S. Cl. CPC C01B 32/05; C08J 3/075; C08J 3/24; C08J 9/283; C08J 9/365; C01P 2004/03; C08J 2201/0524; C08J 2205/026; C08J 2397/00; C08J 2439/00; C08J 2471/02

(57) ABSTRACT

A method of forming a carbon foam precursor for use in the formation of carbon foam materials. The carbon foam precursor comprises an aerogel of polymeric material which has a coating layer thereon, the coating layer comprising a material susceptible to dielectric heating, for example carbon nanotubes. The carbon foam precursor is suitable for forming into a carbon foam material using a dielectric heating step, despite the aerogel of polymeric material not being susceptible to dielectric heating, without adversely affecting the structure and physical properties of the carbon foam so formed. A carbon foam precursor, a carbon foam material and a method of forming such a carbon material are also disclosed.

### FIELD

The present invention relates to a carbon foam precursor, a method of preparing a carbon foam precursor for a carbon foam material formation process and a method of forming a carbon foam material. In particular the invention relates to carbon foam precursors which can be carbonized using dielectric heating.

### BACKGROUND

Carbon based materials have become crucial for many technological developments in areas such as energy, aerospace, automobiles, catalysis and medicine. In particular, carbon foams have become a very important class of carbon-based materials due to their porous structure which can be tuned depending on the final application. Therefore carbon foam materials have enormous potential in technological areas where a light weight and a large surface area are important for the function of the material, such as in electrodes for batteries, absorbents and structural panels for construction, automotives and aircraft.

Typically, carbon foams are produced from petroleum-based precursors such as aromatic polyurethanes and pitch. However, recent efforts to reduce the environmental impact of such materials requires new sustainable alternatives to produce carbon-based materials. Lignin can be considered as a green alternative for the production of carbon-based materials. Lignin is a complex organic polymer present in the cell walls of pith, roots, fruit, buds and bark and, along with hemicellulose and cellulose, is one of the most abundant components of lignocellulosic biomass. However, lignin itself performs poorly in the manufacture of carbon-based materials, which makes industrial scale production extremely complicated and difficult.

A key step in the production of carbon foam material is carbonization. In the carbonization step, carbon foam precursors are heated to temperatures in excess of 600° C. in the absence of oxygen to expel non-carbon atoms from the carbon foam precursors. This produces carbon foam materials comprising mainly carbon atoms and very few non-carbon atoms. The carbon foam materials can then be further processed to facilitate incorporation into products.

The carbonization step in carbon foam material production is particularly energy intensive due to the high temperatures involved. Currently, carbon foams are carbonized using traditional heating system such as ovens and furnaces which have relatively high energy consumption, which in turn impacts on the environmental profile and the production costs of carbon foam materials.

It would therefore be desirable to reduce the energy consumption of carbon foam material production processes, particularly the carbonization step, to reduce the environmental impact of carbon foam materials. In particular it may be desirable to make such a reduction in energy consumption in the processing of lignin-based carbon foam precursors, which as mentioned above are themselves less environmentally damaging than other carbon foam precursors, in order to further reduce the environmental impact of carbon foam material production.

### SUMMARY OF THE INVENTION

It is one aim of the present invention, amongst others, to provide a carbon foam precursor, a method of preparing a carbon foam precursor for a carbon foam formation process and a method of forming a carbon foam material, that addresses at least one disadvantage of the prior art, whether identified here or elsewhere, or to provide an alternative to existing methods. For instance, it may be an aim of the present invention to provide a carbon foam precursor which can be carbonized into a carbon foam material using less energy than current carbon foam precursors.

According to aspects of the present invention, there is provided a carbon foam precursor and methods as set forth in the appended claims. Other features of the invention will be apparent from the dependent claims, and from the description which follows.

According to a first aspect of the present invention, there is provided a method of preparing a carbon foam precursor for a carbon foam formation process, the method comprising the steps of:

A method of preparing a carbon foam precursor for a carbon foam formation process, the method comprising the steps of:
a) forming an aerogel from a polymeric material;
b) forming a coating layer on the aerogel of polymeric material wherein the coating layer comprises a dielectric heating susceptor material.

The inventors have found that by incorporating a coating layer containing a dielectric heating susceptor material, the carbon foam precursors produced by the method of this first aspect can be carbonized using dielectric heating, such as microwave (MW) and radio frequency (RF) heating which may use less energy than known methods of carbonizing known carbon foam precursors. The susceptibility of lignin to dielectric heating is very low and therefore carbonization of such carbon foam precursors using dielectric heating was found to be ineffective. Providing the coating comprising a dielectric heating susceptor material allows such carbon foam precursors, for example lignin-based carbon foam precursors, to be effectively carbonized using dielectric heating, without adversely affecting the structure and physical properties of the main body of the carbon foam (produced from the aerogel of polymeric material after carbonization).

The aerogel of polymeric material on which the coating is provided may be any suitable carbon foam precursor material. This aerogel is intended to be converted to a carbon foam material by carbonization and any other process step required. The dielectric heating susceptor material, which may provide the advantageous dielectric heating carbonization of the carbon foam precursor, is located in the coating layer and suitably not in the polymeric material. The coating layer on the aerogel of polymeric material is suitably also penetrated into pores of the aerogel, therefore coating the inside/pore surfaces of the aerogel.

The polymeric material of the aerogel is suitably substantially free of the dielectric heating susceptor material or any other dielectric heating susceptor material. The aerogel of polymeric material is suitably unresponsive to dielectric heating, suitably having a dielectric constant of less than 20, suitably less than 10 or less than 5.0.

The inventors have found that providing the dielectric heating susceptor material within the polymeric material of the aerogel may have the drawbacks of inhomogeneous distribution of the susceptor material and a larger amount of susceptor material being required to have the desired effect. Perhaps most importantly, providing the dielectric heating susceptor material in the polymeric material of the aerogel may cause defects to form in the carbon foam material produced from the carbon foam precursor during carbonization, which adversely affects the mechanical properties of said carbon foam material. Therefore the carbon foam precursors formed by the method of this first aspect may advantageously use a lower amount of susceptor material than would otherwise be required and may also avoid the structural defects produced by using susceptor materials within the polymeric material of the aerogel, whilst enabling carbonization by dielectric heating with the reduced energy consumption described above.

Step a) involves forming an aerogel from a polymeric material. Step a) provides an aerogel of the polymeric material. The aerogel may be formed using any suitable method, for example by gas bubbling through the polymeric material, powder sintering or in situ gas generation within the polymeric material.

In some embodiments, the aerogel is formed from a hydrogel of the polymeric material. Therefore the method may comprise the steps of:
a1) forming a hydrogel from a polymeric material;
a2) forming an aerogel of polymeric material from the hydrogel; and
b) forming a coating layer on the aerogel of polymeric material wherein the coating layer comprises a dielectric heating susceptor material.

Step a1) of the method involves forming the polymeric material into a hydrogel. Suitable methods of forming a hydrogel from a precursor solution (or dispersion) may be known in the art. For example, such methods may include cooling and/or casting a precursor solution into a desired shape and may involve crosslinking of the hydrogel.

Suitably step a) of the method involves a step a1) of treating the polymeric material with a crosslinking agent. Suitably the crosslinking agent forms sufficient crosslinks between molecules of the polymeric material to form the hydrogel. Suitably the crosslinking agent is chemically matched to, i.e. reactive towards, the polymeric material to allow such crosslinks to form. The crosslinking agent may be selected from epichlorohydrin, a diglycidyl ether, glutaraldehyde, a carbodiimide or a dinvinylsulfone.

Suitably the crosslinking agent is a diglycidyl ether. Suitably the crosslinking agent is poly(ethylene glycol) diglycidyl ether (PEGDGE), especially when the polymeric material is lignin.

Step a2) involves forming an aerogel of polymeric material from the hydrogel. Any suitable method of converting a hydrogel to an aerogel may be used. Suitably step a2) involves lyophilising the hydrogel to form an aerogel of polymeric material.

The polymeric material may be formed from a synthetic polymer or a biologically derived polymer, or a mixture thereof. Suitably the polymeric material is a biologically derived polymeric material.

Suitable biologically derived or “natural” polymers include lignin. Suitably the polymeric material comprises lignin. Suitably the polymeric material consists essentially of lignin or consists of lignin.

It is believed that any type of lignin can be utilised in the polymeric material, for example lignin obtained from softwood, hardwood or grass/annual plants. Suitable lignin can be obtained from these sources using various known processes, for example the Kraft, organosolve or soda processes. In some embodiments, more than one type and/or source of lignin is used to provide the lignin of the polymeric material. Lignin is not sufficiently susceptible to dielectric heating for it to be used for carbonizing, without adding dielectric heating susceptor materials.

The method of this first aspect involves step b) of forming a coating layer on the aerogel of polymeric material wherein the coating layer comprises a dielectric heating susceptor material.

The coating layer is suitably a substantially uniform coating over the aerogel of polymeric material of the carbon foam precursor.

Suitably the coating layer comprises a polymeric carrier material. Suitably the polymeric carrier material is an ionic polymer. A suitable ionic polymer may be selected from poly(diallyldimethylammonium chloride) (PDDA), poly(styrenesulfonate) (PSS), polyacrylic acid (PAA), poly(allylamine hydrochloride), a carboxymethyl cellulose, an alginate or mixtures thereof.

Suitably the coating layer comprises a surfactant. Suitably the surfactant is compatible with and/or can interact with the polymeric carrier material and the dielectric heating susceptor material, in order to stabilise the dielectric heating susceptor material in the coating on the aerogel of polymeric material. Suitably the surfactant is an ionic surfactant. The surfactant may be selected from sodium deoxycholate (DOC), cetrimonium bromide (CTAB), sodium dodecyl sulfate (SDS) or sodium dodecylbenzenesulfonate (SDBS), or mixtures thereof. Suitably the surfactant is DOC.

Suitably the dielectric heating susceptor material is present in the coating layer in a greater amount than the polymeric carrier material and the surfactant (when present).

Suitably the polymeric carrier material and the surfactant are both ionic. Suitably the polymeric carrier material is cationic and the surfactant is anionic, or the polymeric carrier material is anionic and the surfactant is cationic. This may provide an ionic interaction between the polymeric carrier material and the surfactant which stabilises the coating layer comprising the dielectric heating susceptor material on the aerogel of polymeric material.

The coating layer comprises the dielectric heating susceptor material. By dielectric heating susceptor material we mean to refer to a material, for example a particulate material, which absorbs electromagnetic radiation and converts said electromagnetic radiation to heat. For example, the dielectric heating susceptor material may absorb radio frequency radiation and/or microwave radiation and convert said radiation to heat. Suitably the dielectric heating susceptor material absorbs electromagnetic radiation and converts said electromagnetic radiation to heat to a greater extent than the aerogel of polymeric material, suitably to a much greater extent. Suitably the dielectric heating susceptor material absorbs electromagnetic radiation and converts said electromagnetic radiation to heat to a sufficient extent to heat and carbonize the carbon foam precursor to produce carbon foam material.

The dielectric heating susceptor material is suitably selected from any one or more of hollow nanospheres, nanotubes, nanofibres, nanosheets, graphene, graphene derivatives and nano/micro hybrids. The dielectric heating susceptor material may also be nanorods, suitably carbon nanorods. These materials may be alternatively or additionally defined as low dimensional particles, for example particles with at least one nanoscale dimension or component.

Suitably the dielectric heating susceptor material is nanoscale particles. Suitably the dielectric heating susceptor material has a particle size in the range of 50 nm to 1,000 nm (measured by transmission electron microscopy (TEM) using standard techniques).

Suitably the dielectric heating susceptor material comprises carbon nanotubes. Suitably the dielectric heating susceptor material is formed of carbon nanotubes.

In the context of the present invention, the term “carbon nanotube” refers to a structure conceptually similar to that made by rolling up a sheet of graphene into a cylinder. Depending on the rolling degree and the way the original graphene sheet is formed, carbon nanotubes of different diameter and internal geometry can be formed. Carbon nanotubes formed by rolling up of a single sheet forming the aforementioned cylinder, are called “single-walled” carbon nanotubes (SWCNTs). The carbon nanotubes formed by rolling up more than one sheet of graphene with a structure that resembles a series of concentric cylinders of increasing diameters from the center to the periphery are called “multi-walled” carbon nanotubes (MWCNTs).

Suitably the dielectric heating susceptor material comprises multiwalled carbon nanotubes. Suitably the dielectric heating susceptor material is formed of multi-walled carbon nanotubes (MWCNTs).

In embodiments wherein the carbon nanotubes are multi-walled carbon nanotubes, the multi-walled carbon nanotubes suitably comprise from 2 to 5 graphitic layers.

The carbon nanotubes suitably have a high aspect ratio (length-to-diameter ratio), suitably an aspect ratio of between 10 and 10,000,000 to 1, suitably between 100 and 10,000,000 to 1. The carbon nanotubes are also suitably highly graphitic.

Suitably the dielectric heating susceptor material provides from 0.01 to 0.1 wt % of the carbon foam precursor.

Suitably step b) provides a coating on the aerogel having a thickness of from 5 to 200 nm, suitably from 10 to 150 nm, suitably from 20 to 125 nm or from 25 to 100 nm. The inventors have found that this thickness of a coating comprising a dielectric heating susceptor material is sufficient to heat the aerogel of polymeric material during a dielectric heating process to a temperature which carbonizes the aerogel to form a carbon foam material. During said dielectric heating process, the coating composition becomes part of the carbon foam material.

Suitably the carbon foam precursor produced in the method of this first aspect comprises an aerogel of polymeric material and a coating layer on the aerogel, the coating layer comprising carbon nanotubes (as a dielectric heating susceptor material) and a surfactant, the coating layer having a thickness of from 10 to 150 nm.

Suitably the carbon foam precursor comprises an aerogel of lignin, suitably crosslinked lignin, and a coating layer on the aerogel, the coating layer comprising carbon nanotubes (as a dielectric heating susceptor material) and a surfactant, the coating layer having a thickness of from 10 to 150 nm.

Suitably the carbon foam precursor comprises an aerogel of lignin, suitably crosslinked lignin, and a coating layer on the aerogel, the coating layer comprising carbon nanotubes (as a dielectric heating susceptor material) an ionic surfactant and an ionic polymeric carrier material, the coating layer having a thickness of from 10 to 150 nm.

Suitably the carbon foam precursor consists essentially of an aerogel of polymeric material and a coating layer on the aerogel, the coating layer consisting essentially of a dielectric heating susceptor material, a surfactant and a polymeric carrier material, as defined above.

Suitably the carbon foam precursor consists of an aerogel of polymeric material and a coating layer on the aerogel, the coating layer consisting essentially of a dielectric heating susceptor material, a surfactant and a polymeric carrier material, as defined above.

Suitably step b) of the method involves contacting the aerogel of polymeric material with a liquid comprising the dielectric heating susceptor material.

Suitably step b) of the method involves immersing the aerogel of polymeric material in a liquid comprising the dielectric heating susceptor material.

Suitably step b) involves the steps of:
b1) contacting the aerogel of polymeric material with a liquid comprising a polymeric carrier material;
b2) contacting the aerogel of polymeric material with a liquid comprising the dielectric heating susceptor material.

Suitably step b1) coats the aerogel of polymeric material with the polymeric carrier material and step b2) coats the polymeric carrier material with the dielectric heating susceptor material, to form a coating on the aerogel of polymeric material comprising both the polymeric carrier material and the dielectric heating susceptor material.

Suitably step b) involves the steps of:
b1) immersing the aerogel of polymeric material in a liquid comprising a polymeric carrier material as defined above;
b2) after step b1) immersing the aerogel of polymeric material into the liquid comprising the dielectric heating susceptor material.

Suitably the liquid of step b1) comprises the polymeric carrier material in an amount suitable for applying a coating of the desired thickness onto the aerogel of polymeric material. This may depend on the method of application of the liquid to the aerogel. Suitably the liquid of step b1) comprises 0.1 to 1.0 wt % polymeric carrier material, suitably 0.1 to 0.5 wt % polymeric carrier material, suitably wherein the liquid is applied to the aerogel by dipping, suitably wherein the polymeric carrier material is an ionic polymer. Suitably the liquid of step b1) is an aqueous liquid.

Suitably the liquid of step b2) comprises the dielectric heating susceptor material in an amount suitable for applying the desired amount of dielectric heating susceptor material onto the aerogel of polymeric material. This may depend on the method of application of the liquid to the aerogel. Suitably the liquid of step b2) comprises 0.001 to 0.1 wt % dielectric heating susceptor material, suitably 0.01 to 0.1 wt % dielectric heating susceptor material, suitably 0.03 to 0.07 wt % suitably wherein the liquid is applied to the aerogel by dipping, suitably wherein the dielectric heating susceptor material is MWCNTs. Suitably the liquid of step b2) is an aqueous liquid.

Suitably the steps b1) and b2) are repeated at least once.

Steps b1) and b2) may be carried out in the order step b1) followed by step b2), or in the reverse order. Suitably steps b1) and b2) are carried out in the order step b1) followed by step b2). Steps b1) and b2) may each be carried out multiple times, either sequentially or alternately. Suitably steps b1) and b2) are carried out alternately and are repeated multiple times. Suitably steps b1) and b2) are both repeated from 3 to 15 times, suitably from 5 to 12 times, suitably from 5 to 10 times. The inventors have found that repeating the steps b1) and b2) in this way may provide an effective coating comprising dielectric heating susceptor material without adversely affecting the carbon foam precursors.

Suitably after step b1) and before step b2) the aerogel of polymeric material is rinsed with a solvent. Suitably the solvent is water. Suitably after step b2) and before a repeat of step b1) the aerogel of polymeric material is rinsed with a solvent. Suitably the solvent is water.

Suitably after step b1) and before step b2) the aerogel of polymeric material is dried, suitably after being rinsed with a solvent such as water. Suitably after step b2) and before a repeat of step b1) the aerogel of polymeric material is dried, suitably after being rinsed with a solvent such as water.

Suitably the liquid comprising the dielectric heating susceptor material further comprises a surfactant, as defined above. Suitably the surfactant is present in an amount which provides from 0.1 to 5.0 wt % of the liquid comprising the dielectric heating susceptor material, suitably from 0.1 to 2.0 wt %, suitably from 0.5 to 1.5 wt %, suitably wherein the surfactant is an ionic surfactant.

The method of this first aspect suitably provides a carbon foam precursor which is suitable for carbonizing to form a carbon foam material using dielectric heating and therefore may be carbonized in a more energy efficient process than known carbon foam precursors which require conventional oven or furnace heating.

According to a second aspect of the present invention, there is provided a method of forming a carbon foam material, the method comprising the steps of:
1) preparing a carbon foam precursor according to a method of the first aspect;
2) exposing the carbon foam precursor to electromagnetic radiation to heat the carbon foam precursor to a temperature of at least 400° C. to carbonize the carbon foam precursor to form the carbon foam material.

The carbon foam precursor may have any of the suitable features and advantages described in relation to the first aspect.

The steps of the method are carried out in the order step 1) followed by step 2).

Suitably in step 2) the carbon foam precursor is heated to a temperature of from 400° C. to 2,000° C., suitably from 600° C. to 1,500° C., suitably from 800° C. to 1,200° C. or from 600° C. to 1,000° C.

Suitably the electromagnetic radiation is microwave frequency radiation or radio frequency radiation. Suitably the electromagnetic radiation is microwave frequency radiation, suitably having a frequency of from 1 to 300 GHZ. Suitably step 2) is carried out in a microwave heater, for example a microwave oven, for example having a frequency of microwave radiation of 2.45 GHz and a power output of 700 W. Suitably step 2) is carried using a microwave heater having a power output in the range 100 to 700 W.

Suitably step 2) involves exposing the carbon foam precursor to microwave frequency radiation for 2 to 60 minutes, suitably 5 to 45 minutes, suitably 10 to 30 minutes, for example approximately 20 minutes.

Suitably step 2) involves exposing the carbon foam precursor to microwave frequency radiation of frequency 1 to 300 GHZ, of power output of 700 W for 2 to 60 minutes, suitably 5 to 45 minutes, suitably 10 to 30 minutes, for example approximately 20 minutes.

According to a third aspect of the present invention, there is provided a carbon foam precursor comprising an aerogel of a crosslinked polymeric material and a coating layer on the aerogel, the coating layer comprising a dielectric heating susceptor material.

The carbon foam precursor, aerogel, coating layer and dielectric heating susceptor material may have any of the suitably features and advantages described in relation to the first aspect.

The carbon foam precursor is suitable for forming into a carbon foam material using a dielectric heating step, as described above.

Suitably the carbon foam precursor of this third aspect is formed according to a method of the first aspect.

Suitably the crosslinked polymeric material comprises lignin and the dielectric heating susceptor material comprises carbon nanotubes, preferably multiwalled carbon nanotubes.

Suitably the coating layer comprises a surfactant and a polymeric carrier material.

According to a fourth aspect of the present invention, there is provided a carbon foam material formed from the method according to the second aspect. The carbon foam material suitably comprises a dielectric heating susceptor, as defined above in relation to the first aspect on its surface.

### BRIEF DESCRIPTION OF THE FIGURES

FIG. 1 shows a graph of the temperature profiles of the lignin foams during microwave carbonisation.

FIG. 2 shows an SEM image of the carbonised lignin foam of Example 2.

FIG. 3 shows plots of the thermogravimetric analysis of the pre-carbonisation lignin carbon foam precursor of Example 1.

FIG. 4 shows plots of the compression test results for the lignin samples before and after carbonisation.

### EXAMPLES

### Materials

Alcell organosolv hardwood lignin (TCA, Tecnaro GMbH, Ilsfeld, Germany) with a Mw of 4000 g/mol. Sodium hydroxide (NaOH) pellets of greater than or equal to 98% purity was purchased from AppliChem GmbH (Ilsfeld, Germany). Poly(ethylene glycol) diglycidyl ether (PEGDGE) (Mw 500 g/mol) was purchased from Sigma-Aldrich (St. Louis, MI, United States). Elicarb MWCNTs were obtained from Thomas Swan and Co. LTD (United Kingdom). Poly(diallyldimethylammonium chloride) (PDDA), with a molecular weight of 100,000-200,000 g/mol, sodium deoxycholate (DOC) (C₂₄H₃₉NaO₄) were purchased from Sigma-Aldrich (St. Louis, MI, United States).

### Preparation of the Lignin Precursor Foams

A lignin precursor foam was prepared by a hydrogel formation method using PEGDGE as crosslinker as follows. Lignin (8 g) was initially dissolved in 20 ml of 3.3M NaOH solution. The solution was magnetically stirred for 24 h at 60° C. to dissolve the lignin into the NaOH solution. Then, lignin solutions were loaded with PEGDGE (8 g) as crosslinker. The solutions were magnetically stirred during 15 min to provide a homogeneous mixture. Then, the solutions were poured into 4 cm Petri dishes until completion the crosslinking (24 h). Finally, the crosslinked hydrogels were moulded in 1 cm cylinders and rinsed several times with deionized water until a neutral pH was obtained. To produce the foams (aerogels), the hydrogels were freeze-dried in a Eurotherm freeze dryer using the conditions described below. Prior to undergoing the freeze-drying process, the hydrogels were stored at 80° C. overnight. A first step was carried out at 30° C. for 8 h at atmospheric pressure followed by a primary drying at 10° C. for 16 h at 0.1 mBar. Finally, secondary drying was carried out at 20° C. for 2 h at 0.1 mBar.

### MW Susceptor Coating Process

The aerogel of Example 1 was impregnated with a CNTs water-based suspension using the layer-by-layer assembly as follows. 0.05 wt % multi-walled carbon nanotubes were dispersed in an aqueous solution 1 wt % DOC. The MWCNT suspension was sonicated for 30 min, followed by 20 min of 15 W tip sonication in an ice-water bath, and another 30 min of bath sonication to homogenize. The MWCNT dispersion was then centrifuged at 4000 rpm for 20 min and the supernatant was decanted. The aerogel was immersed into the cationic PDDA (0.25 wt %) solution for 5 min, followed by rinsing and drying, and then dipped into the anionic MWCNT-DOC suspension for another 5 min. This process results in one deposition sequence of a PDDA/MWCNT-DOC bilayer (BL). After the initial BL was deposited, all subsequent layers were deposited with 2 min dip times, with rinsing and drying in between. This cycle was repeated to deposit the desired number of bilayers (5 layers in this particular case) to provide the lignin carbon foam precursor of Example 1.

### Carbonisation of Carbon Foam Precursor

Samples of the lignin carbon foam precursor Example 1 were carbonised in a domestic microwave oven modified with a quartz Erlenmeyer, IR temperature sensor and N2 nitrogen flow. FIG. 1 shows the temperature of the lignin carbon foam precursors as a function of the time during the microwave heating process. The samples were heated in two different modes, continuous power to produce the carbon foam material Example 2 and pulsed controlled power to produce the carbon foam material Example 3. The results indicate an effective microwave heating in terms of seconds reaching temperatures higher than 600° C. The maximum temperature can be controlled by adding more cycles to the coating process and adjusting the power output of the microwave.

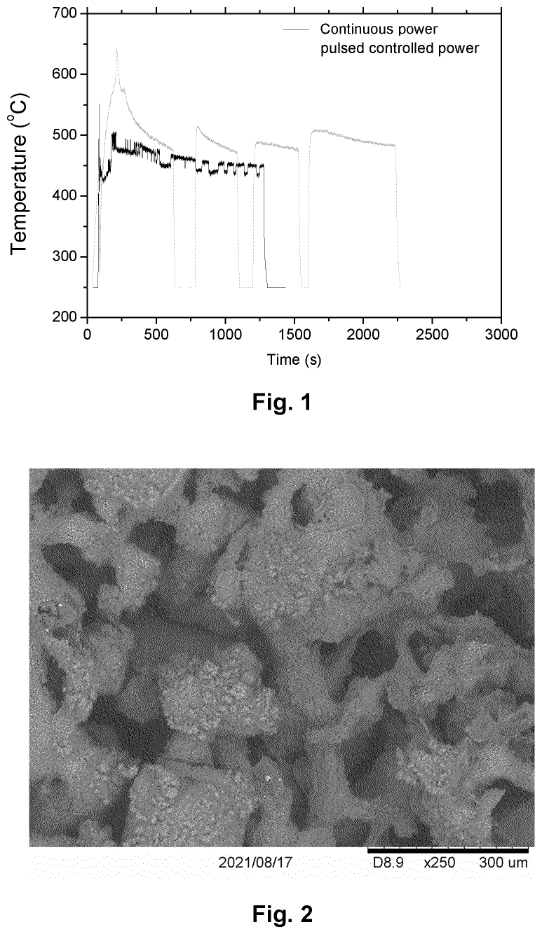

The samples carbonised by microwave heating kept their initial cylindrical shape indicating a good morphological retention. FIG. 2 shows an SEM image of the carbonised lignin foam of Example 2. This SEM image depicts a macroporous morphology typical in carbon foam materials.

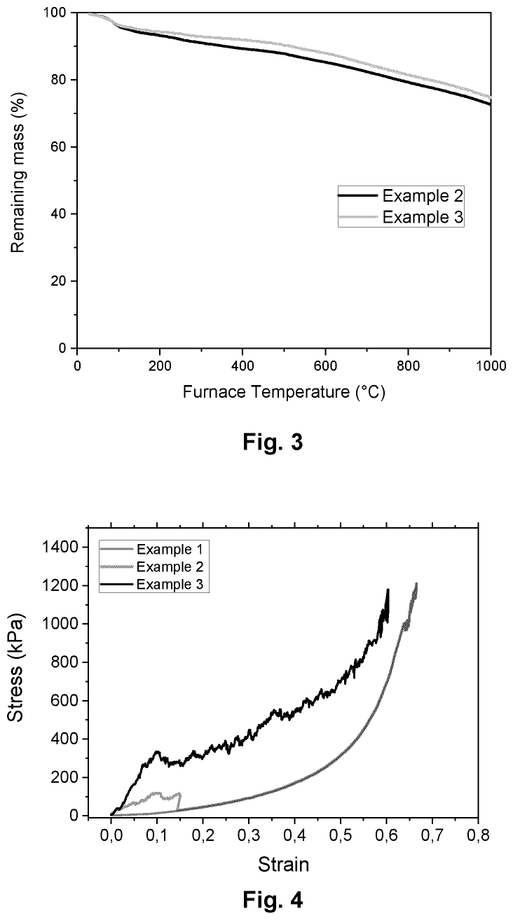

FIG. 3 shows thermograms obtained by thermogravimetric analysis of the pre-carbonisation lignin carbon foam precursor of Example 1 and the post-carbonisation carbon foam materials of Example 2 and Example 3. The results indicate a mass retention grater the 70% at 1000° C. This is evidence of high carbon conversion achieved with the microwave heating induced by the dielectric heating susceptors in the coating layer. A higher carbon conversion can be obtained at longer heating times and with a larger amount of dielectric heating susceptors.

FIG. 4 shows results of a compression test carried out on the carbon foam precursor samples before carbonisation and the carbon foam samples after carbonisation. The results indicate an improvement in the mechanical properties of the carbon foam material samples carbonised using MW heating. The values of the compression modulus were 104, 4181 and 1082 kPa, for the lignin carbon foam precursor, the carbon foam after carbonisation with pulsed controlled power and the carbon foam after carbonisation with continuous power, respectively. The results indicate that the pulsed controlled heating improves the mechanical properties of the carbon foam due to a better carbon phase formation.

In summary, the present invention provides a method of forming a carbon foam precursor for use in the formation of carbon foam materials. The carbon foam precursor comprises an aerogel of polymeric material which has a coating layer thereon, the coating layer comprising a material susceptible to dielectric heating, for example carbon nanotubes. The carbon foam precursor is suitable for forming into a carbon foam material using a dielectric heating step, despite the aerogel of polymeric material not being susceptible to dielectric heating, without adversely affecting the structure and physical properties of the carbon foam so formed. A carbon foam precursor, a carbon foam material and a method of forming such a carbon material are also provided.

Although a few preferred embodiments have been shown and described, it will be appreciated by those skilled in the art that various changes and modifications might be made without departing from the scope of the invention, as defined in the appended claims.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding addition of other components.

Whenever appropriate, depending upon the context, the use of the term “comprises” or “comprising” may also be taken to encompass or include the meaning “consists essentially of” or “consisting essentially of”, and may also be taken to include the meaning “consists of” or “consisting of”.

For the avoidance of doubt, wherein amounts of components in a composition are described in wt %, this means the weight percentage of the specified component in relation to the whole composition referred to. For example, “the liquid comprises 0.001 to 0.1 wt % dielectric heating susceptor material” means that from 0.001 to 0.1 wt % of the liquid is provided by the dielectric heating susceptor material.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A method of preparing a carbon foam precursor for a carbon foam formation process, the method comprising the steps of:
a) forming an aerogel from a polymeric material; and
b) forming a coating layer on the aerogel of polymeric material wherein the coating layer comprises a dielectric heating susceptor material.

2. The method according to claim 1, wherein step a) comprises the steps of:
a1) forming a hydrogel from a polymeric material; and
a2) forming an aerogel of polymeric material from the hydrogel.

3. The method according to claim 1, wherein step a) comprises a step of treating the polymeric material with a crosslinking agent.

4. The method according to claim 1, wherein the polymeric material comprises lignin.

5. The method according to claim 1, wherein step b) involves immersing the aerogel of polymeric material in a liquid comprising the dielectric heating susceptor material.

6. The method according to claim 5, wherein step b) involves the steps of:
b1) immersing the aerogel of polymeric material in a liquid comprising a polymeric carrier material; and
b2) after step b1) immersing the aerogel of polymeric material into the liquid comprising the dielectric heating susceptor material.

7. The method according to claim 6, wherein after step b1) and before step b2) the aerogel of polymeric material is rinsed with a solvent.

8. The method according to claim 6, wherein the steps b1) and b2) are repeated at least once.

9. The method according to claim 5, wherein the liquid comprising the dielectric heating susceptor material further comprises a surfactant.

10. The method according to claim 1, wherein the dielectric heating susceptor material comprises carbon nanotubes.

11. A method of forming a carbon foam material, the method comprising the steps of:
1) preparing a carbon foam precursor according to a method of claim 1; and
2) exposing the carbon foam precursor to electromagnetic radiation to heat the carbon foam precursor to a temperature of at least 400° C. to carbonize the carbon foam precursor to form the carbon foam material.

12. The method according to claim 11, wherein step 2) involves exposing the carbon foam precursor to microwave frequency radiation having a frequency of from 1 to 300 GHz for 2 to 60 minutes.

13. A carbon foam precursor comprising an aerogel of a crosslinked polymeric material and a coating layer on the aerogel, the coating layer comprising a dielectric heating susceptor material.

14. The carbon foam precursor according to claim 13, wherein the crosslinked polymeric material comprises lignin and the dielectric heating susceptor material comprises carbon nanotubes.

15. The carbon foam precursor according to claim 13, wherein the coating layer comprises a surfactant and a polymeric carrier material.

16. A carbon foam material formed from the method according to claim 11.

17. The method according to claim 10, wherein the carbon nanotubes include multiwalled carbon nanotubes.

18. The carbon foam precursor according to claim 14, wherein the carbon nanotubes include multiwalled carbon nanotubes.
